(19) United States
(12) Patent Application Publication
(10) Pub. No.: US 2011/0315834 A1
(43) Pub. Date: Dec. 29, 2011

(54) Tripod with an automatic height-adjuster

(75) Inventors: Sasha Lukic, Buchs (CH); Manfred Ammann, Lauterach (AT); Holger Max Emberger, Buchs (CH); Andreas Winter, Feldkirch (AT); Andreas John, Berschis (CH)

(73) Assignee: Hilti Aktiengesellschaft, Schaan (LI)

(21) Appl. No.: 13/135,147

(22) Filed: Jun. 27, 2011

(30) Foreign Application Priority Data
Jun. 28, 2010 (DE) 10 2010 030 592.8

(51) Int. Cl. F16M 11/24

(52) U.S. Cl. 248/125.8

(57) ABSTRACT

A tripod (1) for the automatic height adjustment of a device (2) in a height direction (12), including a tripod head (3), tripod legs (4) that are connected to the tripod head (3), a receiver (9) to receive the device (2), and a guide (11) that is connected to the receiver (9) and that can be adjusted in the height direction (12), wherein an automatic height-adjuster (13) is provided for adjusting the height of the guide (11).

This claims the benefit of German Patent Application DE 10 2010 030 592.8, filed Jun. 28, 2010 and hereby incorporated by reference herein.

The invention relates to a tripod for the automatic height adjustment of a device in a height direction.

### BACKGROUND

For purposes of carrying out leveling and marking work indoors as well as outdoors, laser devices are known that generate punctiform and/or linear laser beams. The laser beams serve to show reference points or reference lines on walls, ceilings and floors. When it comes to such laser devices, a distinction is made between rotation lasers, which generate a linear laser beam by rotating a source of laser beams or a beam-deflecting lens system around an axis of rotation, and punctiform and/or linear lasers, which generate punctiform and/or linear laser beams by means of beam-forming lens systems such as cylindrical lenses and prisms.

In order to project a laser beam onto a wall at a certain height, the laser device has to be positioned at the appropriate height. Holders are generally known with which laser devices can be fastened to a wall, to a wall-mounted rail or a ceiling-mounted rail, to a pipe and/or to a magnetic structure, as well as tripods that are positioned freestanding on a substrate. Tripods usually have a tripod plate to which a laser device, a tripod head and three tripod legs can be attached. The height of the tripod can be changed by means of the length of the tripod legs and by their standing position on the substrate as well as by the angle of tilt of the tripod legs. The height of the tripod plate is adjusted relative to the stationary tripod head by means of a toothed rack that is moved by means of a crank.

The maximum permissible laser output is limited for laser devices that can be used without protective equipment such as goggles. When leveling and marking work is performed outdoors, the permissible laser outputs often yield laser beams that are hardly or not at all visible. In order to improve the visibility of the laser beams, laser receivers are held in the laser beam. Laser receivers, as handheld devices, are held by an operator directly in the laser beam or else they are attached to a telescopic or leveling rod. The laser beam is displayed optically and indicated acoustically on the laser receiver.

### SUMMARY OF THE INVENTION

The prior art tripods with a manual height-adjustment means have the drawback that, especially when the work is performed outdoors where the visibility is limited, the tripod cannot be set to the desired height, designated below as the target position, by one operator alone and a second person is necessary. The first operator monitors the laser receiver while the second operator changes the height setting of the tripod until the tripod is arranged in the target position.

It would be desirable to improve a height-adjustable tripod in order to overcome the above-mentioned drawbacks.

It is an object of the present invention to put forward a tripod that can be adjusted from an actual position into a target position by one single operator. In order for the tripod to be easy to handle and transport, the tripod should also be compact and resistant to external influences.

According to the invention, an automatic height-adjustment means or automatic height-adjuster is provided for adjusting the height of the guiding device. Automatic height adjustment has the advantage over manual height adjustment that the operator can set the height from a remote location using a remote control. While the operator holds a laser receiver in the laser beam and reads off the difference between the actual position and the target position, he can use the remote control to adjust the height of the tripod.

Preferably, the height-adjustment means is arranged on the underside of the tripod head facing the tripod legs. This arrangement of the height-adjustment means translates into a compact structure for the tripod during transportation since there is no need for additional space for the height-adjustment means.

In a preferred embodiment, the tripod legs are connected to the tripod head by means of articulated joints, and they can be changed between a standing position in which the tripod is ready to use and a transport position for transporting and storing the tripod. Especially preferably in the transport position, the height-adjustment means is essentially completely surrounded by a protective space encompassed by the tripod head, the tripod legs and the articulated joints. If the tripod falls onto a flat substrate or onto a flat obstacle having a large surface area when it is in the transport position, the impact affects the tripod legs, the tripod head and/or the articulated joints, which absorb most of the energy.

The tripod head and/or the articulated joints are preferably at least partially made of a material that has a higher energy-absorption capacity than a housing that surrounds the height-adjustment means. In case of a fall, most of the energy is absorbed by the tripod head and by the articulated joints, so that the risk of damage to the height-adjustment means is reduced.

In a preferred embodiment, the height-adjustment means has a drive unit that interacts with the guiding device, and an overload-protection device, said overload-protection device uncoupling the guiding device from the drive unit if a maximum load is exceeded. The drive unit especially preferably consists of an electric motor and a self-locking reduction gear that interacts with a guiding device configured as a toothed rack. In case of a fall, the overload-protection device, which is integrated as a friction clutch into the reduction gear, ensures that the self-locking of the reduction gear is switched off, so that the toothed rack can move relative to the height-adjustment means. As a result, damage to the drive unit and/or to the guiding device is prevented or at least reduced.

Embodiments of the invention will be described below with reference to the drawing. The drawing does not necessarily depict the embodiments true-to-scale, but rather, they are presented in schematic and/or slightly distorted form whenever necessary for the sake of clarity. Regarding additions to the teaching that can be derived directly from the drawing, reference is hereby made to the pertinent state of the art. In this context, it should be taken into consideration that many modifications and changes can be made in terms of the form and the details of a given embodiment, without departing from the general idea of the invention. The features of the invention disclosed in the description, in the drawing as well as in the claims, be it individually or in any desired combination, can all be essential for refining the invention. Moreover, all combinations of at least two of the features disclosed in the description, in the drawing and/or in the claims fall within the scope of the invention. The general idea of the invention is not limited to the exact form or details of the preferred embodiment shown and described below, nor is it limited to an object that would be restricted in comparison to the object claimed in the claims. Regarding the dimensional ranges given, values that are within the cited limits can also be disclosed as limit values and can be employed and claimed as desired.

For the sake of clarity, the same reference numerals will be used below for identical or similar parts or for parts having an identical or similar function.

Other advantages, features and details of the invention ensue from the description below of preferred embodiments as well as from the drawing.

### BRIEF DESCRIPTION OF THE DRAWINGS

The following is shown:

FIG. 1—a tripod according to the invention that has an automatic height-adjustment means and that is arranged in a standing position;

FIG. 2—the tripod according to the invention as shown in FIG. 1, in a transport position; and

FIG. 3—a top view of the tripod according to the invention as shown in FIG. 2, in the transport position.

### DETAILED DESCRIPTION

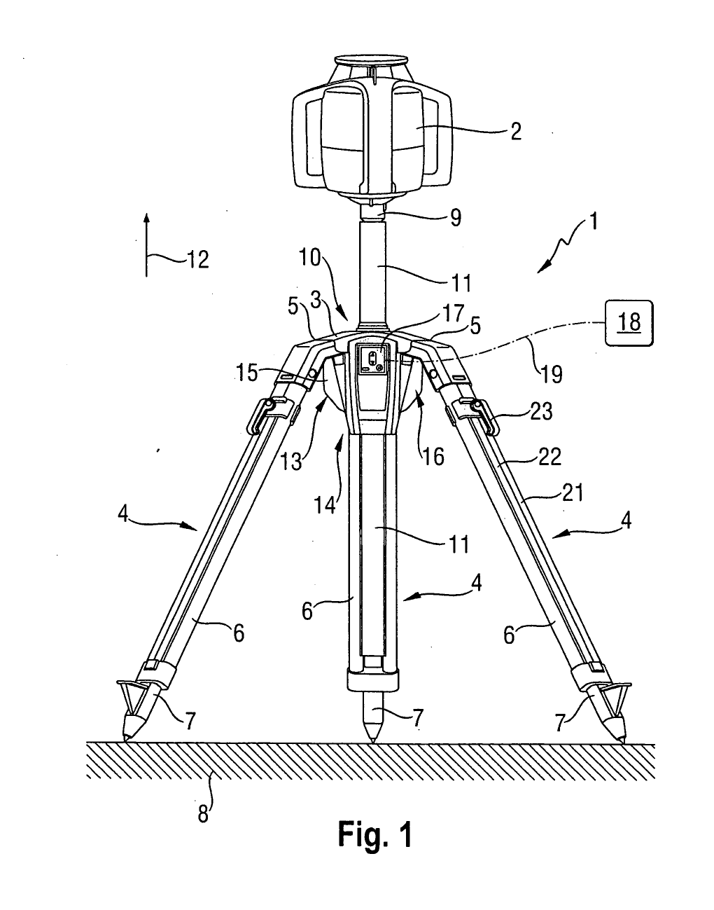

FIG. 1. shows a tripod 1 according to the invention that has an automatic height-adjustment means and that is arranged in a standing position, with a laser device 2 attached to the tripod 1. The tripod 1 is configured so as to be adjustable between the standing position in which the laser device 2 can be employed for leveling and marking work, and a transport position that serves for the transportation and storage of the tripod 1. Aside from laser devices, other measuring devices or optical instruments such as cameras, which all fall under the designation “device”, can be attached to the tripod 1.

The tripod 1 comprises a tripod head 3 and three tripod legs 4 that are configured so as to be identical and connected to the tripod head 3 by means of articulated joints 5. The tripod legs 4 can be swiveled relative to the tripod head 3 within an angular range by means of the articulated joints 5. The tripod legs 4 consist of an upper leg section 6, which is configured as a tube or profile and connected to the articulated joints 5, and a lower leg section 7, which is configured as the tripod foot and is placed onto a substrate 8. Depending on the substrate 8, the tripod legs 4 have different tripod feet 7 in order to ensure that the tripod 1 stands securely on the substrate 8.

The laser device 2 is detachably attached to an adjustable receiving means or adjustable receiver 9 that is configured as a tripod plate. Alternatively, the receiving means 9 can be configured as a threaded rod that is screwed into a matching thread of the laser device 2 in order to attach the laser device 2 onto the tripod 1. The tripod plate 9 is arranged on the side of the tripod head 3 that is facing away from the substrate 8 and that is referred to as the top 10 of the tripod head 3 and that is connected to a guiding device or guide 11. The guiding device is configured as a toothed rack 11 and it can be moved in a direction parallel to the lengthwise extension of the toothed rack 11, which is referred to as the height direction 12, namely, between a lower end position and an upper end position. In the lower end position, the distance between the tripod plate 9 and the tripod head 3 is at a minimum, while in the upper end position, the distance between the tripod plate 9 and the tripod head 3 is at a maximum.

The height of the tripod plate 9 in the height direction 12 relative to the tripod head 3 is adjusted by means of an automatic height-adjustment means or automatic height-adjuster 13 that is arranged on a side of the tripod head 3 that is facing the tripod legs 4 and that is referred to as the bottom 14. The height-adjustment means 13 consists of a housing 15, a drive unit 16 located in the housing 15, and an operating device 17 that is integrated into the housing 15 and that can be operated from the outside. Aside from the operating device 17 integrated into the housing 15, there is also another operating device in the form of a remote control unit 18 that is connected to the drive unit 16 by means of a wireless communication connection 19, for example, in the form of a radio or infrared connection. The height-adjustment means 13 is supplied with power via disposable or rechargeable batteries that are placed into a battery compartment in the housing 15 of the height-adjustment means 13. In addition, a charging connection that can be connected to a power cable can also be provided.

The drive unit 16 is configured, for instance, as a motor drive, a hydraulic drive or pneumatic drive. The height-adjustment means 13 has a safety device, namely, an overload-protection device that uncouples the guiding device 11 from the drive unit 16 if a maximum load is exceeded. In the embodiment shown in FIG. 1, the guiding device is configured as a toothed rack 11, and the drive unit is configured as a motor-driven drive unit 16. The drive unit 16 consists of an electric motor and of a self-locking reduction gear that contains a friction clutch as the overload-protection device. The friction clutch ensures that the self-locking of the reduction gear is switched off and that the toothed rack 11 is uncoupled from the reduction gear in case of a fall or of another event during which the maximal load is exceeded, so that the toothed rack 11 can move relative to the drive unit 16.

The maximum height of the tripod 1 in the height direction 12 is dependent on the length and on the standing position of the tripod legs 4 as well as on the length of the toothed rack 11. For stability reasons, the toothed rack 11 should not be configured too long. In order to extend the height range of the tripod 1, the tripod legs 4 consist of an outer profile section 21 and an inner profile section 22 that can be slid telescopically into each other. The profile sections 21, 22 can be clamped with respect to each other by means of a clamping mechanism 23 that is configured in the form of a clamping lever. The height of the tripod 1 is set roughly by means of the adjustable tripod legs 4. The precise setting of the tripod 1 at the target position is done using the height-adjustment means 13.

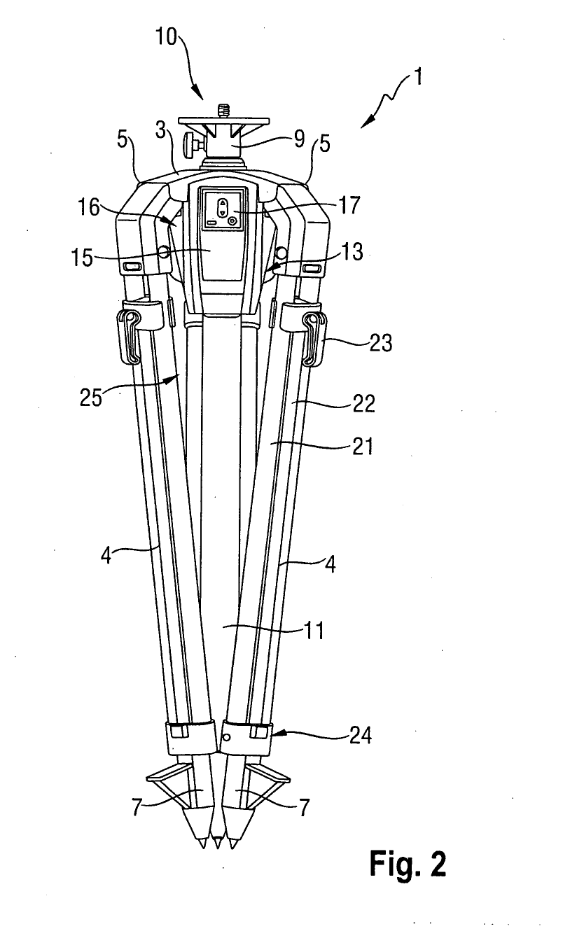

FIG. 2 shows the tripod 1 according to the invention as shown in FIG. 1, in the transport position that serves to transport and store the tripod 1.

In order to change the tripod 1 from the standing position shown in FIG. 1 into the transport position, the laser device 2 is removed from the tripod plate 9 and the guiding rod 11 is moved into the lower end position by means of the height-adjustment means 13. This is still done while the tripod 1 is in the standing position with the height-adjustment means 13 switched on. The height-adjustment means 13 is subsequently switched off. In the case of tripods 1 that have . tripod legs 4 with an adjustable length, the inner profile section 22 of the tripod legs 4 is slid into the outer profile section 21 up to the stop and then secured in place by means of the clamping device. In order for the tripod 1 to be configured so that it is compact in the transport position and so as to be resistant to external influences, the tripod legs 4 are first folded together and subsequently affixed by means of the fixing means 24. The fixing means 24 prevents the tripod legs 4 from moving around the articulated joints 5.

The height-adjustment means 13 is arranged on the underside 14 of the tripod head 3 facing the tripod legs 4. This arrangement of the height-adjustment means 13 translates into a compact structure of the tripod 1 in the transport position since there is no need for additional space for the height-adjustment means 13. The space between the tripod legs 4 cannot be used for other purposes. Another advantage of this arrangement of the height-adjustment means 13 is that the height-adjustment means 13 is protected by the tripod legs 4, by the articulated joints 5 and by the tripod head 3 when the tripod 1 is being transported. The height-adjustment means 13 is completely positioned in a protective space 25 that is encompassed by the tripod head 3, by the tripod legs 4, and by the articulated joints 5.

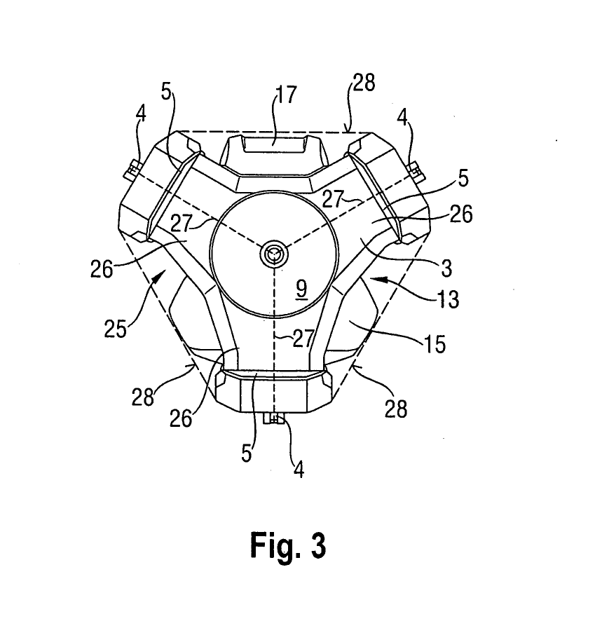

FIG. 3 shows the tripod 1 according to the invention as shown in FIG. 2, in the transport position in a top view of the tripod plate 9, the tripod head 3, the articulated joints 5 and the housing 5 of the height-adjustment means 13.

The tripod 9 is arranged on the top 10 of the tripod head 3 and is connected to the guiding rod 11. The tripod head 3 is configured in the form of a Y with three legs 26 so as to be symmetrical around a center point that coincides with the center point of the guiding rod 11. The center lines 27 of the legs 26 each enclose an angle of 120°. The articulated joints 5 that connect the tripod head 3 to the tripod legs 4 are arranged symmetrically on the ends of the legs 26 facing away from the center point.

The height-adjustment means 13 is arranged completely in the protective space 25 that is formed by the tripod head 3, by the tripod legs 4 and by the articulated joints 5. The protective space 25 is not a completely enclosed space; it is configured so as to be open between the articulated joints 5 and between the tripod legs 4. The top view of the tripod 3 in FIG. 3 shows that the articulated joints 5 are configured as projections and that they protrude to such an extent that the housing 15 of the height-adjustment means 13 does not intersect with or touch the flat connection surfaces 28 that lie between the articulated joints 5 and the tripod legs 34.

If the tripod 1 falls while in the transport position onto a flat substrate or onto a flat obstacle having a large surface area, the impact affects the tripod legs 4, the tripod head 3 and/or the articulated joints 5. The tripod head 3 and/or the articulated joints 5 are made of a material that has a higher energy absorption capacity than the housing 15 of the height-adjustment means 13. Most of the energy is absorbed by the tripod head 3, by the tripod legs 4 or by the articulated joints 5 in such a way that the risk of damage to the height-adjustment means 13 is reduced.

What is claimed is:

1. A tripod for automatic height adjustment of a device in a height direction, comprising:
a tripod head;
tripod legs connected to the tripod head;
a receiver to receive the device; and
a guide connected to the receiver, the guide being adjustable in the height direction; and
an automatic height-adjuster for adjusting a height of the guide.

2. The tripod as recited in claim 1 wherein the height-adjuster is arranged on an underside of the tripod head facing the tripod legs.

3. The tripod as recited in claim 1 further comprising articulated joints connecting the tripod legs to the tripod head, the legs changeable between a standing position and a transport position.

4. The tripod as recited in claim 3 wherein, in the transport position, the height-adjuster is surrounded by a protective space encompassed by the tripod head, the tripod legs and the articulated joints.

5. The tripod as recited in claim 1 wherein the tripod head and/or articulated joints connecting the tripod legs to the tripod head are at least partially made of a material having a higher energy-absorption capacity than a housing surrounding the height-adjuster.

6. The tripod as recited in claim 1 wherein the height-adjuster has a drive interacting with the guide, and an overload-protection device, the overload-protection device uncoupling the guide from the drive unit if a maximum load is exceeded.

7. The tripod as recited in claim 6 wherein the guide is configured as a toothed rack, and the drive has an electric motor and a reduction gear, the reduction gear comprising a friction clutch as the overload-protection device.
